(19) United States
(12) Patent Application Publication
(10) Pub. No.: US 2026/0324670 A1
(43) Pub. Date: Oct. 22, 2026

(54) COFFEE BEVERAGES AND RELATED BREWING TECHNIQUES

(71) Applicant: 33 Degree Foods LLC, Elgin, TX (US)

(72) Inventor: Christopher G. Hansen, Elgin, TX (US)

(21) Appl. No.: 19/542,599

(22) Filed: Feb. 17, 2026

Related U.S. Application Data
(60) Provisional application No. 63/759,255, filed on Feb. 17, 2025.

(51) Int. Cl. A23F 5/46; A23F 5/10

(52) U.S. Cl. CPC A23F 5/465; A23F 5/105

(57) ABSTRACT

The subject application generally relates to coffee beverages and the preparation of the same. In one aspect, whole bean coffee or ground coffee may be contacted with a solvent including alcohol to extract coffee flavor compounds from the whole bean coffee or ground coffee. The whole bean coffee or ground coffee is removed from the solvent after extraction, and if alcohol concentration exceeds a predetermined threshold alcohol is removed from the solvent to provide a coffee beverage which has an alcohol concentration at or below the predetermined threshold and which may be at least substantially free from alcohol. In some aspects, the solvent and/or the whole bean coffee or ground coffee may be cooled to at or below freezing (e.g., 32° F.) before and/or during their contact with one another.

### CROSS-REFERENCE TO RELATED APPLICATIONS

This application claims priority to U.S. Provisional Patent Application No. 63/759,255 filed on Feb. 17, 2025, the contents of which are incorporated herein by reference in their entirety.

### FIELD

The present disclosure generally relates to coffee beverages and the preparation of the same. More particularly, but not exclusively, the present disclosure relates to methods for brewing coffee, optionally performed at near-freezing or sub-freezing temperatures, with a solvent including alcohol and, after some duration of brewing, providing a coffee beverage which is free, or at least substantially free, from alcohol.

### BACKGROUND

Unless otherwise indicated herein, the materials described herein are not prior art to the claims in the present application and are not admitted to be prior art by inclusion in this section.

Alcohol-based solvents may be used for the extraction of flavor compounds, and coffee beverages including intoxicating amounts of alcohol are known in the art. However, such beverages are intended for consumption with the alcohol retained therein, and the flavors imparted by the alcohol may not be enjoyed in the absence of the alcohol itself.

Further, cold brew coffee has gained widespread consumer adoption due to its smooth flavor profile and reduced perceived acidity relative to hot brewed coffee. Conventional cold brew methods rely on water as the extraction solvent and typically operate at temperatures between approximately 4 °C and 22 °C, often requiring extended extraction times. These methods can still extract bitterness-associated compounds and may fail to efficiently capture certain desirable aromatic and flavor compounds.

In view of the foregoing, there is a need for additional contributions in this area of technology.

The subject matter claimed herein is not limited to implementations that solve any disadvantages or that operate only in environments such as those described above. Rather, this background is only provided to illustrate one example technology area where some implementations described herein may be practiced.

### SUMMARY

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

The present disclosure provides methods for brewing coffee using an alcohol-containing solvent and providing a coffee beverage which is free, or at least substantially free, from alcohol. In one form for example, whole bean coffee or ground coffee is contacted with a solvent including alcohol, optionally diluted with water, to extract coffee flavor compounds. After extraction, the whole bean coffee or ground coffee is removed and if the alcohol concentration in the solvent is above a predetermined threshold, alcohol is removed from the brewed coffee, for example via vacuum distillation, to produce a coffee beverage having an alcohol concentration at or below the predetermined threshold and which may be a substantially non-alcoholic coffee beverage. If the alcohol concentration is at or below the predetermined threshold, then the alcohol removal step may be omitted.

In some forms, the brewing process may performed at a reduced temperature, including at temperatures below about 32 °F. By way of example, the amount of alcohol present in the solvent may dictate the minimum temperature at which the brewing may be conducted while avoiding freezing of the solvent such that the solvent is retained in its liquid state. In some forms, the brewing process is conducted at a temperature corresponding to the minimum temperature of the solvent where the solvent remains a liquid. In some forms, temperature control may be independent of the presence or absence of alcohol in the solvent.

In some forms, the subject matter disclosed herein enables production of coffee beverages exhibiting flavor characteristics associated with alcoholic spirits, without retaining intoxicating levels of alcohol—for example, the coffee beverages may have an alcohol concentration below a predetermined threshold or level and may be free or at least substantially free from the alcohol used during the brewing of the coffee beverage. Optional steps include dilution of the alcohol-containing solvent prior to brewing for cost or consistency control, dilution of the brewed coffee to achieve a desired concentration, and optional recovery of removed alcohol for reuse.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

To further clarify the above and other advantages and features of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The invention will be described and explained with additional specificity and detail through the use of the accompanying drawings in which:

FIGURE 1 illustrates a flow diagram of a coffee brewing process.

### DETAILED DESCRIPTION

Reference will now be made to the drawings to describe various aspects of example embodiments of the invention. It is to be understood that the drawings are diagrammatic and schematic representations of such example embodiments, and are not limiting of the present invention, nor are they necessarily drawn to scale.

The present disclosure generally relates to coffee beverages and the preparation of the same. More particularly, but not exclusively, the present disclosure relates to methods for brewing coffee, optionally performed at near-freezing or sub-freezing temperatures, with a solvent including alcohol and, after some duration of brewing, providing a coffee beverage which has an alcohol concentration below a predetermined level or threshold and is free, or at least substantially free, from alcohol. It will be appreciated that embodiments disclosed herein may be employed in a variety of fields and/or operating environments where the functionality disclosed herein may be useful. Accordingly, the scope of the claims should not be construed to be limited to the exemplary implementations and operating environments disclosed herein.

A method for preparing a coffee beverage includes contacting coffee with a solvent including alcohol. The coffee may be in the form of whole bean coffee (i.e., whole coffee beans) or ground coffee prepared from grinding whole coffee beans. The alcohol included in the solvent may be ethanol or an alcoholic liquor such as whiskey, vodka, rum, gin, tequila, brandy, a flavored liqueur or combinations thereof. In some forms, the alcohol in the solvent may be selected based on the flavor characteristics intended to be imparted thereby on the coffee beverage. For example, the coffee beverage may retain flavor(s) characteristic of the alcohol(s) used during brewing such that the coffee beverage has taste(s) reminiscent of the alcohol(s) used for brewing. The solvent may be diluted to be provided with an alcohol concentration which is at or below a predetermined threshold such that any coffee brewed with the solvent will also have an alcohol concentration which is below the predetermined threshold. In some forms, the predetermined threshold is 0.5% alcohol by volume, although other values are contemplated.

The brewing process may be performed at any desired temperature(s). In some forms for example, the temperature(s) at which the brewing is conducted may be that which yields a coffee beverage which may be characterized as a cold-brewed coffee. In these forms, the temperature(s) may be ambient cold brew temperatures or a temperature corresponding to the minimum temperature of the solvent where the solvent remains a liquid. In some forms, such temperatures may be at or below about 32-33 °F.

The minimum temperature of the solvent where the solvent remains a liquid may be controlled by changing its freezing point. This may be done by varying the alcohol concentration of the solvent and/or increasing the pressure at which the brewing occurs, permitting brewing below 32 °F. Regarding the former approach for changing the freezing point, it should be understood the solvent may include one or more items in addition to alcohol. For example and as mentioned above, in some forms the solvent may also include water, and the ratio of water to alcohol may be selected depending on the temperature at which the brewing will be conducted since increasing alcohol concentration of the solvent will correspondingly decrease the freezing point of the solvent. Similarly, as desired brewing temperatures decrease, solvents with increased alcohol concentration may be used for brewing the coffee. The ratio of alcohol to water may also be selected based on solvent cost, extraction efficiency, the alcohol content of the starting alcoholic liquor, or desired process consistency.

In some forms, the solvent and the whole bean coffee or ground coffee may be contacted/combined together and then cooled to the desired brewing temperature. Alternatively, one or both of the solvent and the whole bean coffee or ground coffee may be cooled to the desired brewing temperature before being contacted/combined with one another or mixed together, and then the mixture is maintained at the desired brewing temperature during the brewing process.

After being combined, the solvent and whole bean coffee or coffee grounds may be maintained in contact for a brewing period sufficient to extract coffee flavor compounds from the whole bean coffee or coffee grounds. While not being limited to any particular value, it is contemplated that the brewing period may be between about 30 minutes and about 3000 minutes, about 300 minutes and about 2100 minutes, about 600 minutes and about 1800 minutes, about 660 minutes and about 1500 minutes, and about 720 minutes and about 1440 minutes.

After completion of the brewing period, the remaining whole bean coffee or coffee grounds are removed from the solvent. The whole bean coffee or ground coffee may be removed by filtration, settling, or other solid-liquid separation techniques by way of non-limiting examples.

After removal of the coffee grounds, alcohol is removed from the brewed coffee if the amount of alcohol exceeds a predetermined threshold to produce a coffee beverage which has an alcohol concentrate at or below the predetermined threshold and many befree, or at least substantially free, from alcohol. For example, in some forms if any trace amounts of alcohol may remain, the concentration of the remaining alcohol may be at a level which does not cause an intoxicating effect when the coffee beverage is consumed by a human being. In some forms for example, if any alcohol remains in the coffee beverage, it may be present at a concentration of less than about 0.5% alcohol by volume. The amount of alcohol included in the brewed coffee may be determined by testing, or it may be known based on known strength of the alcohol included in the solvent and any relevant dilution rates thereof. If the amount of alcohol in the brewed coffee exceeds the predetermined threshold, then alcohol removal is performed. However, if the brewed coffee includes an alcohol concentration which is at or below the predetermined threshold, then alcohol removal procedures may be bypassed.

Alcohol removal may be performed by heating, evaporation, membrane separation, or distillation just to provide a few non-limiting examples. In some forms, vacuum distillation may be used for removing the alcohol. By way of example, vacuum distillation may lower the boiling point of the alcohol-containing mixture, thereby enabling alcohol removal at reduced temperatures while avoiding or minimizing degradation of flavor compounds.

In some embodiments, vacuum conditions are selected to achieve alcohol removal at temperatures below approximately 150 °F, although other variations are possible. For example, in some forms the vacuum distillation may be conducted at temperatures below about 145 °F, 140 °F, 135 °F, 130 °F, 125 °F, 120 °F, 115 °F, 110 °F, 105 °F and 100 °F, although other variations are possible and contemplated. In some forms, alcohol vapors formed during distillation may be captured for reuse in subsequent brewing processes.

Following removal of the whole bean coffee or ground coffee, and removal of alcohol where necessary, the resulting coffee beverage may be diluted to a desired strength using water, milk, almond milk, creamer, soy milk, coconut milk or other beverage components. Dilution may occur after alcohol removal to achieve a target total dissolved solids (TDS) level suitable for consumption. In some forms, the resulting coffee beverage may be produced as a concentrate and diluted prior to serving.

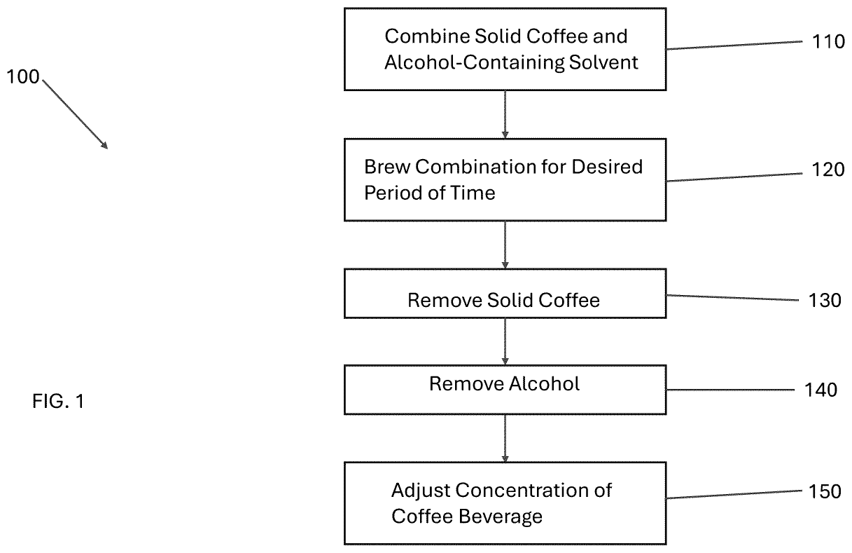

Referring now to FIG. 1, there is illustrated an exemplary process 100 for producing a coffee beverage. In step 110 of the process 100, an alcohol containing solvent is combined with solid coffee, which may be whole bean coffee or ground coffee, for brewing a coffee beverage. The solvent may also contain water, amongst other possibilities, in order to dilute the concentration of the alcohol in the solvent to at or below a predetermined threshold. While not illustrated, the process 100 may include an optional step before step 110 where one or both of the solid coffee and the solvent is cooled to a temperature less than ambient. In some forms, one or both of the solvent and the solid coffee may be cooled to a temperature which is at, below or about the temperature at which the brewing will be conducted.

At step 120, a coffee beverage is brewed from the solid coffee. The brewing may be conducted for a period of time necessary to extract desired flavor profiles/compounds from the solid coffee into the solvent. In addition, in some forms step 120 may be conducted under conditions where the brewing occurs at or around a temperature corresponding to the freezing point of the solvent. In some forms for example, such a temperature may be less than about 32 °F, although other variations are possible.

At step 130, the solid coffee is removed from the solvent by filtration, settling or some other suitable solid-liquid separation technique. At step 140, if the brewed coffee contains an alcohol concentration which exceeds a predetermined threshold, alcohol is removed from the extracted liquid to produce a coffee beverage which has an alcohol concentration at or below the predetermined threshold and which may be free, or at least substantially free, from alcohol. If the brewed coffee includes an alcohol concentration which is at or below the predetermined threshold, then the alcohol removal may be bypassed. In addition to having an alcohol concentration at or below the predetermined threshold and being free, or at least substantially free, from alcohol, the coffee beverage retains flavor profiles/characteristics imparted by the alcohol present in the coffee. For example, in forms where the alcohol includes a rye whiskey, the coffee beverage may retain flavor notes characteristic of flavors present in the rye whiskey. In forms where step 140 is performed, it involves removal of alcohol via vacuum distillation in which reduced pressure lowers a boiling point of the alcohol-containing mixture, allowing removal of alcohol at reduced temperatures to limit thermal degradation of flavor compounds. While not illustrated, the process 100 may include an optional step of capturing alcohol removed from the solvent for reuse in subsequent brewing processes.

At step 150, the coffee beverage may be adjusted to a desired consumption concentration, for example by dilution with water, milk, almond milk, creamer, soy milk, coconut milk or other beverage components, and/or by blending. Forms in which step 150 is not included in the process 100 are also possible and contemplated.

In one embodiment, a method includes contacting whole bean coffee or ground coffee with a solvent comprising alcohol to extract coffee flavor compounds from the whole bean coffee or ground coffee; removing the whole bean coffee or ground coffee from the solvent after extraction; and if alcohol concentration exceeds a predetermined threshold, removing alcohol from the solvent to provide a coffee beverage which has an alcohol concentration at or below the predetermined threshold.

In one form, the solvent comprises a mixture of alcohol and water.

In another form, the solvent comprises one or more liquors.

In yet another form, when performed, removing alcohol from the solvent includes vacuum distillation.

In one aspect of this form, alcohol is removed at a temperature below about 150 °F.

In still another form, the method further includes cooling the solvent to a temperature corresponding to the minimum temperature of the solvent where the solvent remains a liquid.

In one aspect of this form, the method also includes cooling the whole bean coffee or ground coffee to the temperature corresponding to the minimum temperature of the solvent where the solvent remains a liquid.

In another form, the method also includes diluting the coffee beverage after alcohol removal to achieve a desired concentration.

In still another form, the coffee beverage retains flavors imparted by the alcohol of the solvent.

In yet another form, the alcohol of the solvent includes at least one of whiskey, vodka, rum, gin, tequila, brandy, and a flavored liqueur.

In another embodiment, a coffee beverage is produced by a process including exposing whole bean coffee or ground coffee to a solvent including alcohol and, if alcohol concentration exceeds a predetermined threshold, subsequently removing alcohol from the solvent to provide a coffee beverage free from an intoxicating amount of alcohol.

In one form, the coffee beverage retains flavor compounds extracted from the whole bean coffee or ground coffee by the solvent and flavors imparted by the alcohol of the solvent.

In another form, the alcohol of the solvent includes at least one of whiskey, vodka, rum, gin, tequila, brandy, and a flavored liqueur.

In still another form, the coffee beverage further includes a diluting amount of a diluent sufficient for achieving a target total dissolved solids (TDS) level suitable for consumption.

In one aspect of this form, the diluent may be one or more of water, milk, almond milk, creamer, soy milk and coconut milk.

In a further embodiment, a method includes contacting whole bean coffee or ground coffee with a solvent including alcohol at a temperature below about 32 °F; maintaining the solvent and the whole bean coffee or ground coffee below about 32 °F during extraction of coffee flavor compounds from the whole bean coffee or ground coffee; removing the whole bean coffee or ground coffee from the solvent; and, if alcohol concentration exceeds a predetermined threshold, removing alcohol present in the solvent to provide a coffee beverage at least substantially free from alcohol.

In one form, removing alcohol comprises vacuum distillation performed at a temperature below about 150 °F.

In one form, the method further includes diluting the coffee beverage after alcohol removal.

Unless specific arrangements described herein are mutually exclusive with one another, the various implementations described herein can be combined to enhance system functionality or to produce complementary functions. Likewise, aspects of the implementations may be implemented in standalone arrangements. Thus, the above description has been given by way of example only and modification in detail may be made within the scope of the present invention.

With respect to the use of substantially any plural or singular terms herein, those having skill in the art can translate from the plural to the singular or from the singular to the plural as is appropriate to the context or application. The various singular/plural permutations may be expressly set forth herein for sake of clarity. A reference to an element in the singular is not intended to mean “one and only one” unless specifically stated, but rather “one or more.” Moreover, nothing disclosed herein is intended to be dedicated to the public regardless of whether such disclosure is explicitly recited in the above description.

In general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). Furthermore, in those instances where a convention analogous to “at least one of A, B, and C, etc.” is used, in general, such a construction is intended in the sense one having skill in the art would understand the convention (e.g., “a system having at least one of A, B, and C” would include but not be limited to systems that include A alone, B alone, C alone, A and B together, A and C together, B and C together, or A, B, and C together, etc.). Also, a phrase presenting two or more alternative terms, whether in the description, claims, or drawings, should be understood to include one of the terms, either of the terms, or both terms. For example, the phrase “A or B” will be understood to include the possibilities of “A” or “B” or “A and B.”

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
contacting whole bean coffee or ground coffee with a solvent comprising alcohol to extract coffee flavor compounds from the whole bean coffee or ground coffee;
removing the whole bean coffee or ground coffee from the solvent after extraction; and
if alcohol concentration exceeds a predetermined threshold, removing alcohol from the solvent to provide a coffee beverage which has an alcohol concentration at or below the predetermined threshold.

2. The method of claim 1, wherein the solvent comprises a mixture of alcohol and water.

3. The method of claim 1, wherein the solvent comprises one or more liquors.

4. The method of claim 1, wherein when performed removing alcohol from the solvent comprises vacuum distillation.

5. The method of claim 4, wherein alcohol is removed at a temperature below approximately 150 °F.

6. The method of claim 1, further comprising cooling the solvent to a temperature corresponding to the minimum temperature of the solvent where the solvent remains a liquid.

7. The method of claim 6, further comprising cooling the whole bean coffee or ground coffee to the temperature corresponding to the minimum temperature of the solvent where the solvent remains a liquid.

8. The method of claim 1, further comprising diluting the coffee beverage after alcohol removal to achieve a desired concentration.

9. The method of claim 1, wherein the coffee beverage retains flavors imparted by the alcohol of the solvent.

10. The method of claim 1, wherein the alcohol of the solvent includes at least one of whiskey, vodka, rum, gin, tequila, brandy, and a flavored liqueur.

11. A coffee beverage produced by a process comprising exposing whole bean coffee or ground coffee to a solvent comprising alcohol and if alcohol concentration exceeds a predetermined threshold, subsequently removing alcohol from the solvent to provide a coffee beverage free from an intoxicating amount of alcohol.

12. The coffee beverage of claim 11, wherein the coffee beverage retains flavor compounds extracted from the whole bean coffee or ground coffee by the solvent and flavors imparted by the alcohol of the solvent.

13. The coffee beverage of claim 11, wherein the alcohol of the solvent includes at least one of whiskey, vodka, rum, gin, tequila, brandy, and a flavored liqueur.

14. The coffee beverage of claim 11, further comprising a diluting amount of a diluent sufficient for achieving a target total dissolved solids (TDS) level suitable for consumption.

15. A method, comprising:
contacting whole bean coffee or ground coffee with a solvent comprising alcohol at a temperature below about 32 °F;
maintaining the solvent and the whole bean coffee or ground coffee below about 32 °F during extraction of coffee flavor compounds from the whole bean coffee or ground coffee;
removing the whole bean coffee or ground coffee from the solvent; and
if alcohol concentration exceeds a predetermined threshold, removing alcohol present in the solvent to provide a coffee beverage having an alcohol concentration at or below the predetermined threshold.

16. The method of claim 15, wherein removing alcohol comprises vacuum distillation performed at a temperature below about 150 °F.

17. The method of claim 15, further comprising diluting the coffee beverage after alcohol removal.
